(19) United States
(12) Patent Application Publication
(10) Pub. No.: US 2024/0126030 A1
(43) Pub. Date: Apr. 18, 2024

(54) MULTI-CENTER NON-REFLECTIVE TERMINATION AND OPTICAL LINE TEST METHOD

(71) Applicant: NIPPON TELEGRAPH AND TELEPHONE CORPORATION, Tokyo (JP)

(72) Inventor: Yoshitaka ENOMOTO, Musashino-shi, Tokyo (JP)

(73) Assignee: NIPPON TELEGRAPH AND TELEPHONE CORPORATION, Tokyo (JP)

(21) Appl. No.: 18/277,753

(22) PCT Filed: Mar. 25, 2021
(86) PCT No.: PCT/JP2021/012731

§ 371 Date: Aug. 17, 2023

(51) Int. Cl. G02B 6/43

(52) U.S. Cl. CPC G02B 6/43

(57) ABSTRACT

An object of the present invention is to provide a multicore non-reflective terminal portion having a small influence of reflected light on an optical transmission system and having a small number of parts, and an optical path testing method using the same.

A multicore non-reflective terminal portion 70 according to the present invention includes: 2n (n is a natural number) optical fibers 71 each having a vertically polished end face on one end side and an angle-polished end face on the other end side, a 2n-core MT connector 72 that collects the 2n optical fibers 71 and is attached to the one end side of the optical fibers 71, and n-core MT connectors (73a, 73b) attached to the other end side of the optical fibers 71 for each of two groups of the 2n optical fibers 71.

### TECHNICAL FIELD

The present disclosure relates to a multicore non-reflective terminal portion connected to a connector portion of an optical coupler attached to a tape fiber of an optical transmission system, and an optical path testing method using the same.

### BACKGROUND ART

A configuration of a system for measuring an optical fiber coupling a communication facility building and a user will be described with reference to FIGS. 1 and 2. The inside of a communication facility building 10 includes an optical line terminal (OLT) 11, an optical coupler 12, an optical fiber switch 13, an optical testing module (OTM) 14, and an operation terminal 15.

The OLT 11 and a user-side optical network unit (ONU) 21 are coupled by the optical coupler 12 and a tape fiber 50. In addition, the optical coupler 12 and the optical fiber switch 13 are connected by two sets of 8-core tape fibers 31. Here, the 8-core tape fiber 31 and the optical coupler 12 are collectively connected for 16 cores by 16 MT connectors (32a, 32b).

The OTM 14 includes an optical time domain reflectometer (OTDR), optical measuring equipment such as a core wire identifying light source, and a controller that controls them.

The optical fiber switch 13 connects a fiber array 13b in which a plurality of optical fibers is arranged in the width direction on a V-groove substrate 13a and one head fiber 13c moving in the X-axis direction and the Y-axis direction on the V-groove substrate 13a. The optical fiber switch 13 can move the head fiber 13c and select any one core from the optical fibers of the fiber array 13b (see, for example, Patent Literature 1 to 3). Note that there is a minute gap between the fiber array 13b and the head fiber 13c. In order to suppress reflection here, the inside of the optical fiber switch 13 is filled with a refractive index matching material. Therefore, the optical fiber end of the fiber array 13b not connected to the head fiber 13c is also suppressed from causing reflection by the refractive index matching material, and a reflection attenuation amount of 40 dB or more is secured.

In the system of FIG. 1, when the operator selects a core wire to be measured with the operation terminal 15, the head fiber 13c of the optical fiber switch 13 moves on the V-groove substrate 13a in the X direction and the Y direction and is connected to a desired optical fiber of the fiber array 13b. Thereafter, the core wire identifying light and the OTDR test light are incident on the tape fiber 50 from the OTM 14 via the optical coupler 12, and the optical transmission system is tested (see, for example, Non Patent Literature 1).

### CITATION LIST

### Patent Literature

Patent Literature 1: JP 09-080329 A
Patent Literature 2: JP 10-123439 A
Patent Literature 3: JP 2009-10789 A
Patent Literature 4: JP 07-225325 A

### Non Patent Literature

Non Patent Literature 1: Masahito Arii, Yuji Higashi, Yoshitaka Enomoto, Katsuaki Suzuki, Noriyuki Araki, Shigenori Uruno, Joichi Watanabe, “Optical Medium Network Operation Technology Supporting Extending Optical Access Network”, NTT Technical Journal, pp. 58-61, 2006.12

### SUMMARY OF INVENTION

### Technical Problem

In the system for measuring an optical fiber, in a case where the scale of the communication facility building 10 is small such as in a rural area, the optical fiber switch 13 and the OTM 14 may not be introduced into the communication facility building 10. In this case, as illustrated in FIG. 2, the 16 MT connector 32a of the optical coupler 12 is in an opened state, and the communication light from the OLT 11 and the ONU 21 is reflected by a connector end face of the 16 MT connector 32a of the optical coupler 12.

Similarly to 4 MT and 8 MT connectors, the 16 MT connector has a connector end face polished at a right angle, and the reflection attenuation amount of the 16 MT connector may be about 15 dB. In addition, depending on the optical transmission method, the reflected light generated in the 16 MT connector may affect the communication quality between the OLT 11 and the ONU 21. Additionally, there is a risk that communication light from the OLT 11 or the ONU 21 output from the end face of the 16 MT connector 32a may erroneously enter the eyes of the operator.

Therefore, as illustrated in FIG. 3, there is also known a multicore non-reflective terminal portion 60 that is attached to the 16 MT connector 32a and can collectively suppress the reflection generated at the end face of the 16 MT connector 32a (see, for example, Patent Literature 4). The non-reflective terminal portion 60 protects the end face of the 16 MT connector 32a, and can also prevent the communication light from the OLT 11 and the ONU 21 output from the end face of the 16 MT connector 32a from entering the eyes of the operator.

However, as illustrated in FIG. 3, in a case where the non-reflective terminal portion 60 is attached in the manner of fully closing the 16 MT connector 32a, measurement with the OTDR or the like with respect to the tape fiber 50 cannot be performed. Therefore, as illustrated in FIG. 4, instead of attaching the non-reflective terminal portion 60 to the 16 MT connector 32a, a converter 61 that converts the 16 MT connector 32a into two sets of 8 MT connectors 61b is connected, and further, FO (fan-out) cords 62 are connected to the 8 MT connectors 61b. In this manner, the end portion of the 16 MT connector 32a can be divided on a core basis, and reflection can be suppressed by attaching a single-core non-reflective terminal portion 63 to each of those other than the end portion of the measurement target.

In the configuration of FIG. 4, an arbitrary one core of the tape fiber 50 can be measured with the OTDR or the like, and the other core wires, which have the non-reflective terminal portions 63, do not cause reflection to affect the communication quality between the OLT 11 and the ONU 21. Additionally, the communication light from the OLT 11 or the ONU 21 output from the end face of the 16 MT connector 32a can be prevented from entering the eyes of the operator.

However, in order to adopt the configuration of FIG. 4, the converter 61, the FO cords 62, and the single-core non-reflective terminal portions 63 are required. That is, in order to adopt the configuration of FIG. 4, there is a problem that the number of parts is large, it takes time and effort and cost for the non-reflective terminal on a core basis, and a space (hereinafter, may be referred to as an “accommodation space”) for accommodating the converter 61, the FO cords 62, and the single-core non-reflective terminal portions 63 is also necessary.

Therefore, in order to solve the above problem, an object of the present invention is to provide a multicore non-reflective terminal portion having a small influence of reflected light on an optical transmission system and having a small number of parts, and an optical path testing method using the same.

### Solution to Problem

In order to achieve the above object, in the multicore non-reflective terminal portion according to the present invention, an optical fiber end on the side connected to the connector of the optical coupler is as usual, but the end face on the opposite side is angle-polished.

Specifically, the multicore non-reflective terminal portion according to the present invention includes:
2n (n is a natural number) optical fibers each having a vertically polished end face on one end side and an angle-polished end face on the other end side,
a 2n-core MT connector that collects the 2n optical fibers and is attached to the one end side of the optical fibers, and
   n-core MT connectors attached to the other end side of the optical fibers for each of two groups of the 2n optical fibers.

The present multicore non-reflective terminal portion includes only three parts (optical fiber, optical coupler-side connector, and anti-optical coupler side connector) so that the number of components is small. Furthermore, since the optical fiber end portion on the anti-optical coupler side is angle-polished, the light reflected at the end portion does not return to the OLT or the ONU. Note that the “anti-optical coupler side connector” refers to a connector on a side of the optical fiber not connected to the optical coupler, and is the connector (73a, 73b) in FIGS. 5 to 7. Thus, the present invention can provide a multicore non-reflective terminal portion having a small influence of reflected light on an optical transmission system and having a small number of parts.

The present multicore non-reflective terminal portion is preferably connected to the optical coupler as described below.
(1) The 2n-core MT connector is collectively connected to 2n-core input/output ends of an optical coupler provided for an n-core tape fiber that connects n OLTs and n ONUs respectively.
(2) One of the n-core MT connectors is connected, by the 2n-core MT connector, to the other end of the optical fiber having the one end connected to the input/output end capable of inputting and outputting light to and from the ONU among 2n-core input/output ends of the optical coupler.
(3) The other of the n-core MT connectors is connected, by the 2n-core MT connector, to the other end of the optical fiber having the one end connected to the input/output end capable of inputting and outputting light to and from the OLT among 2n-core input/output ends of the optical coupler.

The multicore non-reflective terminal portion according to the present invention further includes an n-core FO (fan-out) cord,
in which the FO cord includes:
an FO-side n-core MT connector attached to a side where the n cores are collected and connected to the n-core MT connector, and
single-core connectors attached to respective cores on a side where the n cores are branched, and
the end portion of each core is angle-polished on both the FO-side n-core MT connector side and the single-core connector side.

The FO cord enables optical testing of any path. Note that the FO cord is desirably used only when the optical testing is performed.

In the n-core MT connector of the multicore non-reflective terminal portion according to the present invention, the entire connector ferrule including the other end of the optical fiber is angle-polished. When a cap is placed, contact between the end face of the optical fiber and the cap can be avoided, and damage to the end face of the optical fiber can be avoided.

The optical path testing method according to the present invention includes: connecting the multicore non-reflective terminal portion to 2n-core input/output ends of the optical coupler provided for an n-core tape fiber that connects n (n is a natural number) OLTs and n ONUs respectively, and
connecting optical measurement equipment to any optical fiber of one of the n-core MT connectors connected to the other end of the optical fiber having the one end connected to the input/output end capable of inputting and outputting light to and from the ONU among 2n-core input/output ends of the optical coupler by the 2n-core MT connector, or the other of the n-core MT connectors connected to the other end of the optical fiber having the one end connected to the input/output end capable of inputting and outputting light to and from the OLT among 2n-core input/output ends of the optical coupler by the 2n-core MT connector.

When connecting the optical measurement equipment, the optical path testing method according to the present invention includes:
connecting an FO-side n-core MT connector attached to a side of an n-core FO (fan-out) cord where the n cores are collected to the n-core MT connector, and
connecting the optical measurement equipment to any of single-core connectors attached to respective cores on a side of the FO cord where the n cores are branched.

Note that the above inventions can be combined as much as possible.

### Advantageous Effects of Invention

The present invention can provide a multicore non-reflective terminal portion having a small influence of reflected light on an optical transmission system and having a small number of parts, and an optical path testing method using the same.

### BRIEF DESCRIPTION OF DRAWINGS

FIG. 1 is a diagram describing a configuration of a system for measuring an optical fiber coupling a communication facility building and a user.

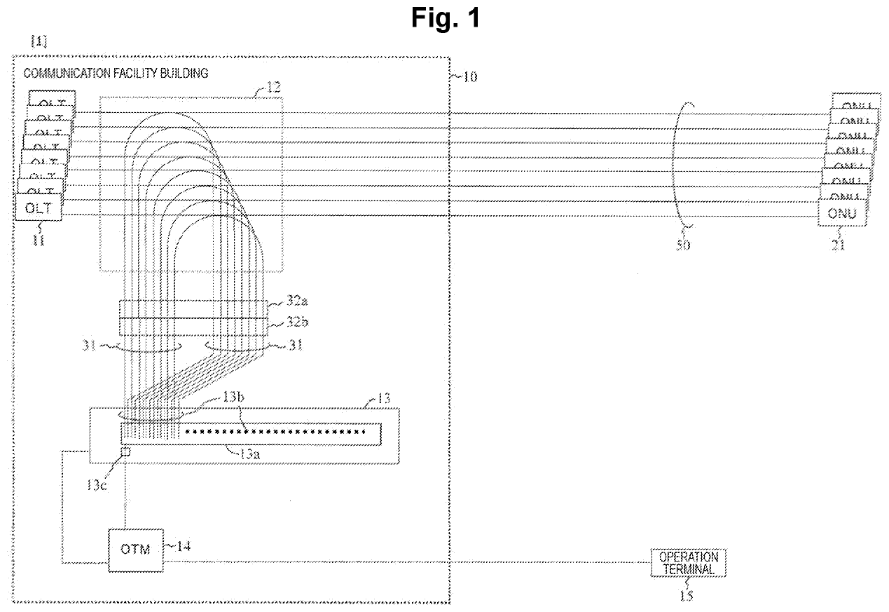

FIG. 2 is a diagram describing a configuration of a system for measuring an optical fiber coupling a communication facility building and a user.

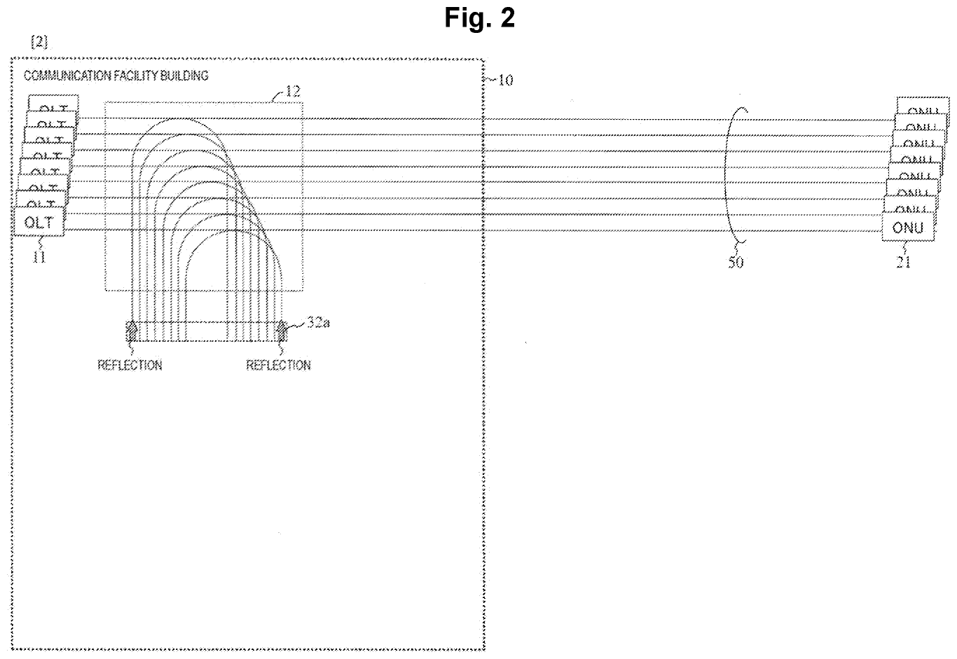

FIG. 3 is a diagram describing a problem of the present invention.

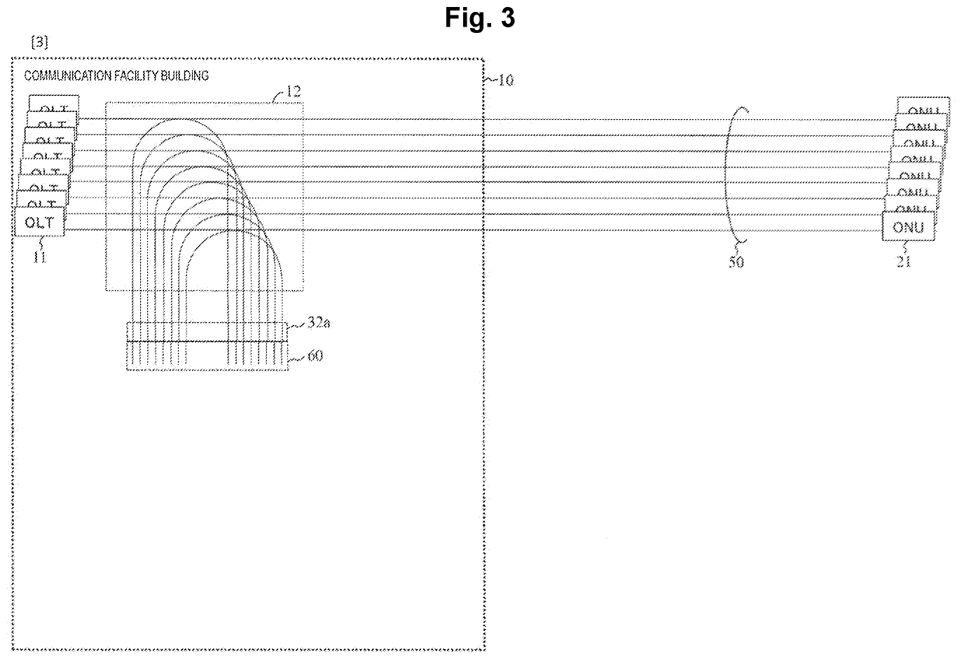

FIG. 4 is a diagram describing a problem of the present invention.

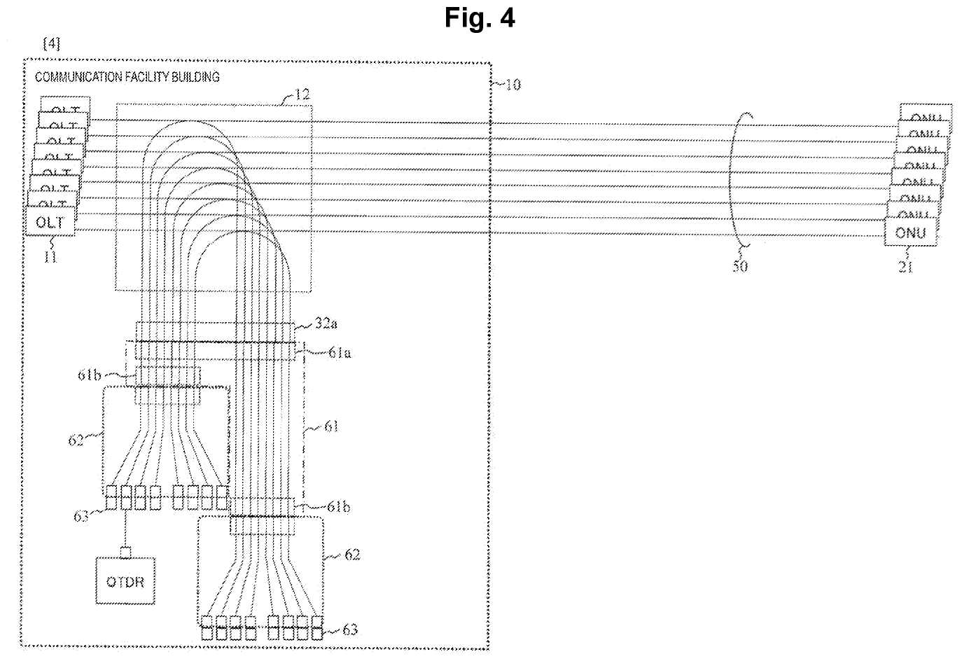

FIG. 5 is a diagram describing a multicore non-reflective terminal portion according to the present invention.

FIG. 6 is a diagram describing a multicore non-reflective terminal portion according to the present invention.

FIG. 7 is a diagram describing a multicore non-reflective terminal portion according to the present invention.

FIG. 8 is a diagram describing a multicore non-reflective terminal portion according to the present invention.

FIG. 9 is a diagram describing an optical path testing method according to the present invention.

### DESCRIPTION OF EMBODIMENTS

Embodiments of the present invention will be described below with reference to the accompanying drawings. The embodiments described below are examples of the present invention, and the present invention is not limited to the embodiments described below. Note that components having the same reference numerals in the present specification and the drawings indicate the same components.

### First Embodiment

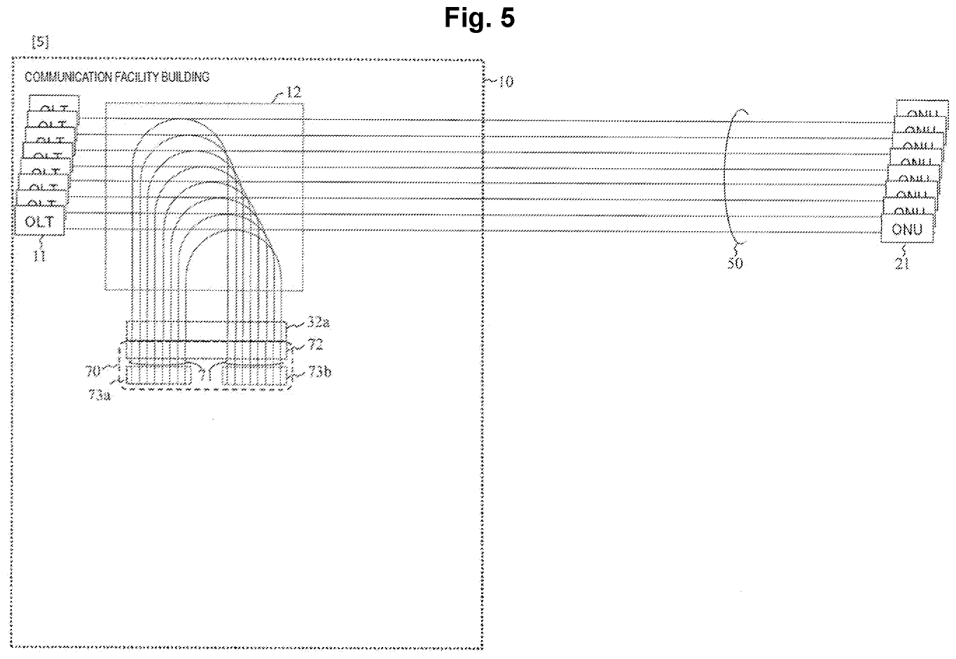

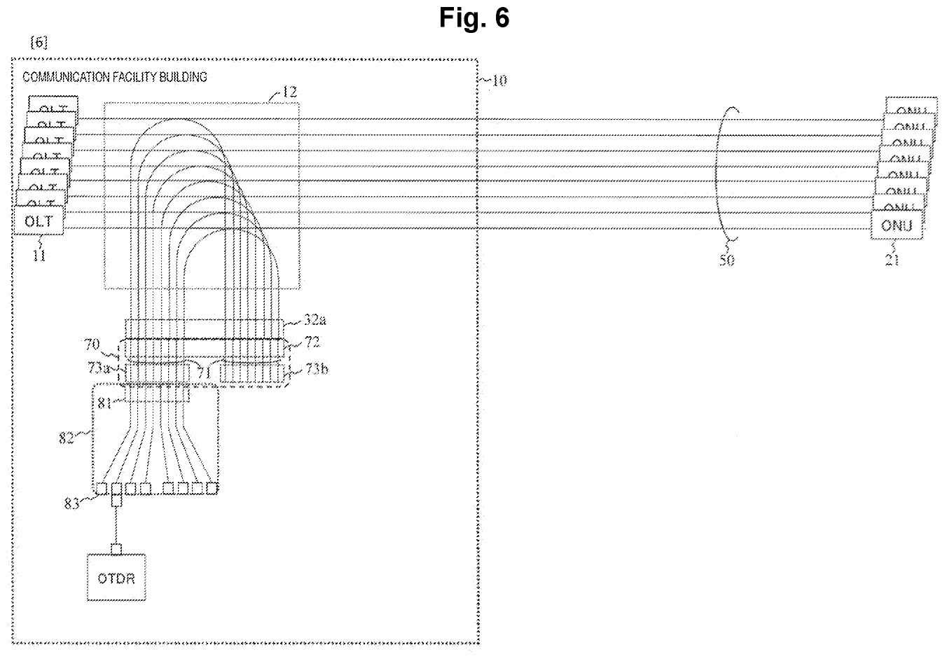

FIGS. 5 and 6 are diagrams describing an optical path testing system that includes a multicore non-reflective terminal portion 70 of the present embodiment and measures an optical fiber 50 coupling the user to the communication facility building 10 of the optical transmission system. The multicore non-reflective terminal portion 70 includes:
2n (n is a natural number) optical fibers 71 each having a vertically polished end face on one end side and an angle-polished end face on the other end side,
a 2n-core MT connector 72 that collects the 2n optical fibers 71 and is attached to the one end side of the optical fibers 71, and
n-core MT connectors (73a, 73b) attached to the other end side of the optical fibers 71 for each of two groups of the 2n optical fibers 71.

In the present embodiment, an example of n=8 will be described. The same applies even when n is other than 8.

The communication facility building 10 includes the optical line terminal (OLT) 11 and the optical coupler 12. In addition, the OLT 11 and the user-side optical network unit (ONU) 21 are coupled by the optical coupler 12 and the tape fiber 50.

In addition, the optical coupler 12 and the multicore non-reflective terminal portion 70 are collectively connected for 16 cores by the 16 MT connectors (32a, 72).

That is, the 2n-core MT connector 72 is collectively connected to 2n-core input/output ends (MT connector) 32a of the optical coupler 12 provided for the n-core tape fiber 50 that connects a plurality of n OLTs 11 and a plurality of n ONUs 21 respectively.

The n-core MT connector 73a is connected, by the 2n-core MT connector 72, to the other end of the optical fibers 71 having the one end connected to the input/output end capable of inputting and outputting light to and from the ONU 21 among 2n-core input/output ends (MT connector) 32a of the optical coupler 12.

The n-core MT connector 73b is connected, by the 2n-core MT connector 72, to the other end of the optical fibers 71 having the one end connected to the input/output end capable of inputting and outputting light to and from the OLT 11 among 2n-core input/output ends (MT connector) 32a of the optical coupler 12.

As illustrated in FIG. 5, communication light from the OLT 11 and the ONU 21 passes through a 16 MT-8 MT conversion portion (portion from the MT connector 72 to the MT connector (73a, 73b)) from the 16 MT connector 32a of the optical coupler 12, and reaches the angle-polished end faces of the optical fibers 71 on the 8 MT connector 73 side. Since the end face is angle-polished, even when the communication light is reflected, the communication light does not return to the direction on the incident side, and the reflected light does not affect the communication quality between the OLT 11 and the ONU 21. Note that the angle at which the end face of the optical fibers 71 is angle-polished is preferably about 8 degrees.

In FIG. 6, in order to measure the tape fiber 50, an FO cord 82 is attached to the 8 MT connector 73a described in FIG. 5, and an OTDR is connected to an arbitrary single-core connector 83 of the FO cord 82.

That is, the multicore non-reflective terminal portion 70 further includes an n-core FO cord 82,
in which the FO cord 82 includes:
an FO-side n-core MT connector 81 attached to a side where the n cores are collected and connected to the n-core MT connector (73a or 73b), and
the single-core connectors 83 attached to respective cores on a side where the n cores are branched, and
the end portion of each core is angle-polished on both the FO-side n-core MT connector 81 side and the single-core connector 83 side.

In other words, the FO cord 82 converts the 8 MT connector 73a in which the end portion of the optical fibers 71 is angle-polished into eight single-core connectors 83 in which the end portion is angle-polished.

As illustrated in FIG. 6, since the end faces of the single-core connectors 83 are also angle-polished, even when the communication light is reflected by the end faces of the single-core connectors 83, the communication light does not return to the direction on the incident side, and the reflected light does not affect the communication quality between the OLT 11 and the ONU 21.

When the OTDR measurement is not performed, the form of FIG. 5 is adopted, and it is sufficient if the FO cord 82 is attached as illustrated in FIG. 6 only when the measurement is performed, so that the accommodation space of the FO cord is unnecessary.

Also in the case of performing the measurement, only the 8 MT connector 81 having an angle-polished end portion is connected to the 8 MT connector 73a in which the end portions of the optical fibers 71 are angle-polished. However, their polishing directions and angles are made to coincide with each other so that no gap is generated between the end portion of the optical fibers 71 and the end portion of the 8 MT connector 81 at the time of connection.

Also when the FO cord 82 is attached, since each connector end face is angle-polished, even when the communication light is reflected by each end face, the communication light does not return to the direction on the incident side, and the reflected light does not affect the communication quality between the OLT 11 and the ONU 21.

Note that when the non-reflective terminal portion 70 is short (for example, 5 cm or less), the accommodation space is further unnecessary.

The present embodiment is an example in which the connector 32a of the coupler 12 is the 16 MT connector, but the non-reflective terminal portion 70 may be a 16 MT-angle-polished 16 MT connector instead of 16 MT-8 MT conversion, and the FO cord may include angle-polished 16 MT connector and 16 single-core connectors.

### Second Embodiment

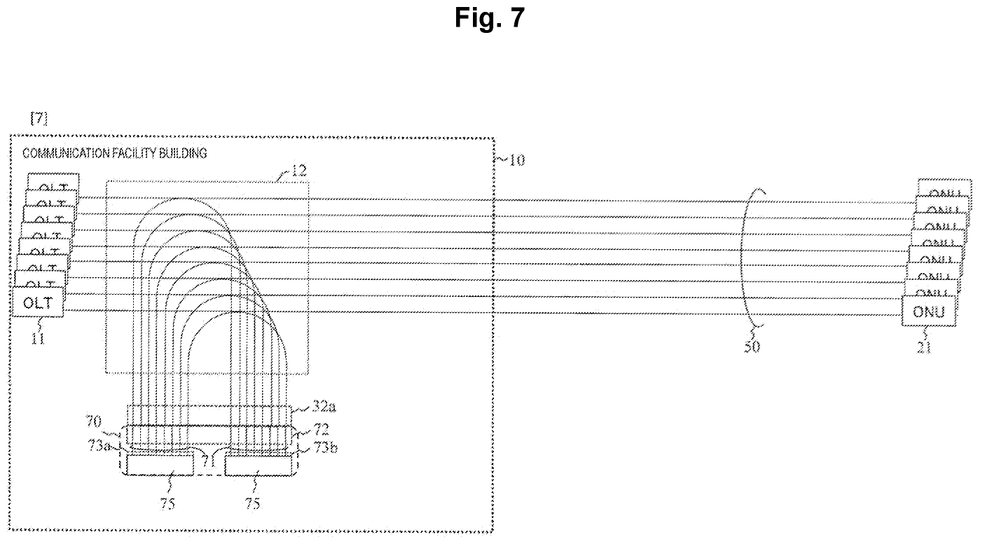

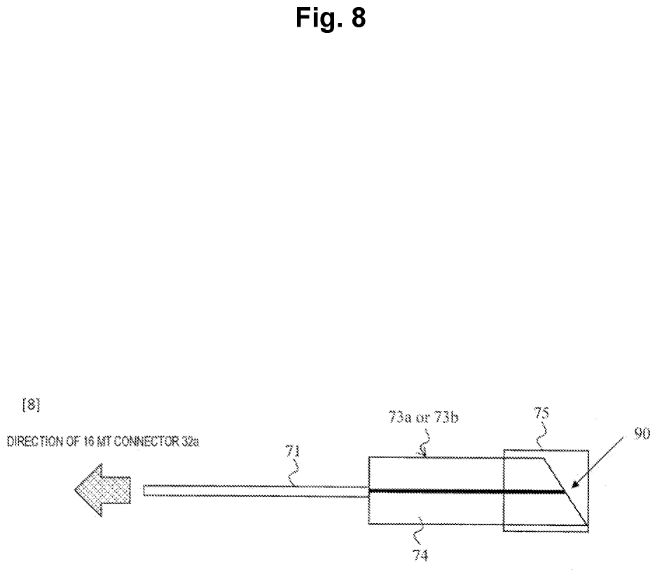

FIGS. 7 and 8 are diagrams describing the multicore non-reflective terminal portion 70 of the present embodiment. In order to protect the end faces of the optical fibers 71 and ensure safety so that the communication light does not enter the eyes of the operator, it is necessary to attach caps 75 to the end faces of the opened 8 MT connectors (73a, 73b).

However, when the end faces of the optical fibers 71 are in contact with the caps 75, the end faces may be damaged instead of being protected due to the influence of the caps 75. Additionally, when the caps 75 come into contact with the end faces of the optical fibers 71, the state of the angle-polished end faces changes, the communication light is reflected by the end faces and returns to the incident side, and the reflected light may affect the communication quality between the OLT 11 and the ONU 21.

Therefore, in the present embodiment, as illustrated in FIG. 8, the entire connector ferrule 74 of the 8 MT connector (73a, 73b) is angle-polished. That is, the n-core MT connector (73a, 73b) is characterized in that the entire connector ferrule 74 including the other ends of the optical fibers 71 is angle-polished.

Since the entire end portion of the connector ferrule 74 is angle-polished, a part of the ferrule 74 is in contact with the inside the cap 75, and a space 90 is formed between the end faces of the optical fibers 71 and the cap 75. In this space 90, the cap can be placed without contacting the end faces of the optical fibers 71. Therefore, in the present embodiment, in addition to the effects described in the first embodiment, the protection of the end faces of the optical fibers 71 and the operator's safety measures can be easily realized.

### Third Embodiment

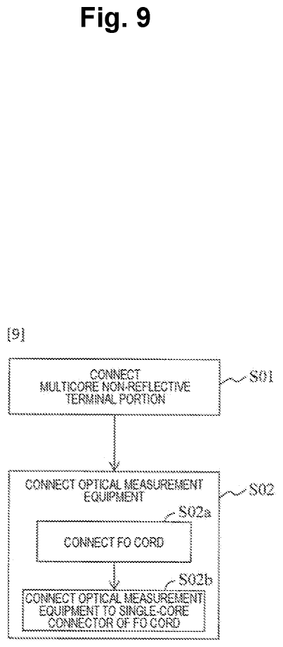

FIG. 9 is a diagram describing the optical path testing method of the present embodiment. The present optical path testing method includes: connecting the multicore non-reflective terminal portion 70 described in the first embodiment to the 2n-core input/output ends (MT connector) 32a of the optical coupler 12 provided for the n-core tape fiber 50 that connects the n OLTs 11 and the n ONUs 21 respectively (step S01); and
connecting optical measurement equipment to any optical fiber 71 of the n-core MT connector 73a connected to the other end of the optical fiber 71 having the one end connected to the input/output end capable of inputting and outputting light to and from the ONU 21 among 2n-core input/output ends (MT connector) 32a of the optical coupler 12 by the 2n-core MT connector 72, or the n-core MT connector 73b connected to the other end of the optical fiber 71 having the one end connected to the input/output end capable of inputting and outputting light to and from the OLT 11 among 2n-core input/output ends (MT connector) 32a of the optical coupler 12 by the 2n-core MT connector 72 (step S02).

Here, in step S02, it is preferable to include:
connecting the FO-side n-core MT connector 81 attached to a side of the n-core FO (fan-out) cord 82 where the n cores are collected to the n-core MT connector (73a or 73b) (step S02a), and
connecting the optical measurement equipment to any of the single-core connectors 83 attached to respective cores on a side of the FO cord 82 where the n cores are branched (step S02b).

### REFERENCE SIGNS LIST

10 Communication facility building
11 OLT (Optical Line Terminal)
12 Optical coupler
13 Optical fiber switch
13a V-groove substrate
13b Fiber array
13c Head fiber
14 OTM (Optical Testing Module)
15 Operation terminal
21 ONU (Optical Network Unit)
31 n-core tape fiber (n=8 in the drawings)
32a, 32b 2n-core MT connector (n=8 in the drawings)
50 Tape fiber (eight cores in the drawings)
60 Non-reflective terminal portion
61 Converter
61a 2n-core MT connector (n=8 in the drawings)
61b n-core MT connector (n=8 in the drawings)
62 FO (fan-out) cord
63 Single-core non-reflective terminal portion
70 Multicore non-reflective terminal portion
71 Optical fiber
72 2n-core MT connector (n=8 in the drawings)
73a, 73b n-core MT connector (n=8 in the drawings)
74 Connector ferrule
75 Cap
81 FO-side n-core MT connector (n=8 in the drawings)
82 FO (fan-out) cord
83 Single-core connector
90 Space

1. A multicore non-reflective terminal portion comprising:
2n (n is a natural number) optical fibers each having a vertically polished end face on one end side and an angle-polished end face on an other end side;
a 2n-core MT connector that collects the 2n optical fibers and is attached to the one end side of the optical fibers; and
n-core MT connectors attached to the other end side of the optical fibers for each of two groups of the 2n optical fibers.

2. The multicore non-reflective terminal portion according to claim 1, wherein
the 2n-core MT connector is collectively connected to 2n-core input/output ends of an optical coupler provided for an n-core tape fiber that connects n OLTs and n ONUs respectively, and
one of the n-core MT connectors is connected to the other end of the optical fiber having the one end connected to the input/output end capable of inputting and outputting light to and from the ONU among 2n-core input/output ends of the optical coupler by the 2n-core MT connector, and
the other of the n-core MT connectors is connected to the other end of the optical fiber having the one end connected to the input/output end capable of inputting and outputting light to and from the OLT among 2n-core input/output ends of the optical coupler by the 2n-core MT connector.

3. The multicore non-reflective terminal portion according to claim 1, further comprising:
an n-core FO (fan-out) cord,
wherein
the FO cord includes:
an FO-side n-core MT connector attached to a side where the n cores are collected and connected to the n-core MT connector, and
single-core connectors attached to respective cores on a side where the n cores are branched, and
an end portion of each core is angle-polished on both the FO-side n-core MT connector side and the single-core connector side.

4. The multicore non-reflective terminal portion according to claim 1, wherein an entire connector ferrule including the other ends of the optical fibers is angle-polished in the n-core MT connector.

5. An optical path testing method comprising:
connecting the multicore non-reflective terminal portion according to claim 1 to 2n-core input/output ends of an optical coupler provided for an n-core tape fiber that connects n (n is a natural number) OLTs and n ONUs respectively; and
connecting optical measurement equipment to any optical fiber of one of the n-core MT connectors connected to the other end of the optical fiber having the one end connected to the input/output end capable of inputting and outputting light to and from the ONU among 2n-core input/output ends of the optical coupler by the 2n-core MT connector, or the other of the n-core MT connectors connected to the other end of the optical fiber having the one end connected to the input/output end capable of inputting and outputting light to and from the OLT among 2n-core input/output ends of the optical coupler by the 2n-core MT connector.

6. The optical path testing method according to claim 5, comprising:
when connecting the optical measurement equipment,
connecting an FO-side n-core MT connector attached to a side of an n-core FO (fan-out) cord where the n cores are collected to the n-core MT connector; and
connecting the optical measurement equipment to any of single-core connectors attached to respective cores on a side of the FO cord where the n cores are branched.
